(19) United States
(12) Patent Application Publication
(10) Pub. No.: US 2017/0247928 A1
(43) Pub. Date: Aug. 31, 2017

(54) SLIDING DOOR

(71) Applicant: SIEMENS AKTIENGESELLSCHAFT, MUNICH (DE)

(72) Inventors: ANDREAS HAEUSSLER, SOLINGEN (DE); THOMAS KUEBECK, GREFRATH (DE)

(21) Appl. No.: 15/506,787

(22) PCT Filed: Aug. 21, 2015
(86) PCT No.: PCT/EP2015/069203

§ 371 Date: Feb. 27, 2017

(30) Foreign Application Priority Data
Aug. 27, 2014 (DE) 102014217081.8

(51) Int. Cl. E05F 15/60; E05B 83/04; E05F 5/00

(52) U.S. Cl. CPC E05F 15/60; E05F 5/003; E05B 83/04; E05Y 2900/112; E05Y 2900/51

(57) ABSTRACT

A sliding door has a brake element for braking the door leaf, an adjustment device configured to switch the brake element over from a braking position, in which the door leaf is being braked, to a release position, in which the door leaf is not being braked, and from the release position to the braking position, and a motor drive unit which is configured to cooperate with the adjustment device and to allow the brake element to be adjusted.

The invention relates to sliding doors, in which door leaves may be opened or closed by sliding, and to vehicles comprising sliding doors.

Sliding doors are used, for example in rail vehicles, as toilet doors. A sliding door with a circular footprint is disclosed, for example, in the German published patent application DE 10 2008 047 792 A1.

In the field of vehicle technology, in particular rail vehicle technology, there is the problem that, when the vehicle accelerates, sliding doors are able to open or close in an undesired and/or automatic manner if they are not securely locked, and even in the case of lateral acceleration of the vehicle, depending on the alignment of the respective sliding door.

Accordingly, the object of the invention is to specify a is sliding door which prevents automatic door leaf movement but is still user-friendly.

This object is achieved according to the invention by a sliding door having the features as claimed in claim 1. Advantageous embodiments of the sliding door according to the invention are disclosed in the subclaims.

Accordingly, it is provided according to the invention that the sliding door comprises: a brake element for braking the door leaf, an adjustment device designed to switch the brake element over from a braking position in which the door leaf is being braked, to a release position in which the door leaf is not being braked, and vice versa from the release position to the braking position and a motorized drive unit which is designed to cooperate with the adjustment device and to allow the brake element to be adjusted.

A substantial advantage of the sliding door according to the invention may be seen to be that an undesirable automatic movement of the door—when the door is not actuated—may be prevented by the brake element provided according to the invention. The brake element may be advantageously adjusted, in particular released, by motor.

In order to permit a manual operation of the sliding door in a simple manner, it is regarded as advantageous if the sliding door has a manual control element for opening and closing the door leaf. It is particularly advantageous if the manual control element is connected to the adjustment device and when actuated permits an adjustment of the brake element from the braking position into the release position.

It is particularly advantageous if—at least in the closed position of the sliding door—a locking of the door leaf, preferably by a positive connection, may be additionally achieved by the manual control element.

Preferably the brake element is suitable for braking the door leaf in at least one intermediate position between the fully open position of the door leaf and the fully closed position of the door leaf. It is, however, particularly advantageous if the brake element is designed to brake the door leaf in any possible intermediate position between the fully open position and the fully closed position of the door leaf.

The brake element preferably produces its braking action by friction. The brake element is preferably a brake shoe or brake piston.

It is also regarded as advantageous if the motorized drive unit is not only able to adjust the brake element but also to displace the door leaf, in particular in the direction of the closed position of the door leaf. In this embodiment, the motorized drive unit exerts a dual function since it serves both for adjusting the brake element and also for adjusting the door leaf.

It is regarded as particularly advantageous if the motorized drive unit is able to displace the door leaf optionally in the direction of the closed position of the door leaf and optionally in the direction of the open position of the door leaf.

The adjustment device may be produced in a simple and cost-effective manner if said adjustment device comprises a is strand-shaped or rod-shaped brake adjusting unit, in particular in the form of a brake rod, a brake tube, a cable or wire, which is connected to the brake element and which in the case of a displacement in its longitudinal direction transfers the brake element from the braking position into the release position or vice versa. The cross section of the brake adjusting unit may be of any type, i.e. for example round, oval or polygonal, in particular triangular or quadrangular.

The adjustment device preferably has a displaceable driver unit, in particular in the form of a driver slide which, by displacement transversely, in particular vertically, to the longitudinal direction of the brake adjusting unit, is able to displace, in particular to lift or lower, the brake adjusting unit in the longitudinal direction thereof.

Relative to the coupling of the driver unit and the brake adjusting unit, it is regarded as advantageous if the driver unit or the brake adjusting unit has a wedge surface which is oriented obliquely to the longitudinal direction and which, in the case of a sliding movement of the driver unit transversely to the longitudinal direction, triggers a movement of the brake adjusting unit in the longitudinal direction.

It is advantageous if the wedge surface is oriented obliquely to the vertical and, in the case of a sliding movement of the driver unit in the horizontal direction, triggers a vertical movement of the brake adjusting unit.

Relative to the arrangement of the driver unit, it is regarded as advantageous if the driver unit is able to be displaced along the same linear or curved sliding path, the door leaf being displaced along said path when the sliding door is opened or closed.

Alternatively or additionally, the driver unit and the brake adjusting unit may be coupled together via at least one coupling rod which, in the case of a sliding movement of the driver unit transversely to the longitudinal direction of the brake adjusting unit, triggers a movement of the brake adjusting unit in the longitudinal direction thereof.

Relative to the arrangement of the components to one another, it is regarded as advantageous if the motorized drive unit, the adjustment device and the door leaf are arranged relative to one another such that the motorized drive unit, when started up to adjust the door leaf, initially acts on the adjustment device and permits the brake element to be transferred from the braking position into the release position before the door leaf is driven.

It is particularly advantageous if the motorized drive unit, the adjustment device and the door leaf are arranged such that the motorized drive unit, when started up to adjust the door leaf, initially displaces the displaceable driver unit transversely to the longitudinal direction of the brake adjusting unit and relative to the door leaf, whereby the brake element is transferred from the braking position into the release position and namely until the driver unit strikes against a stop on the door leaf side, and that after the driver unit comes to bear against the stop the drive force of the motorized drive unit is transmitted to the door leaf and the door leaf is displaced via the driver unit bearing against the stop.

The adjustment device preferably comprises a spring drive which transfers the brake element indirectly or directly, in particular by the cooperation of the driver unit, from the release position into the braking position as soon as the motorized drive unit is inactive.

It is also advantageous if the motorized drive unit comprises a drive roller, in particular in the form of a friction roller, which bears against the driver unit at least during operation of the motorized drive unit and is set in rotational motion for adjusting the adjustment device and the door leaf, wherein the drive roller, when rotated by friction and/or a positive connection, initially leads to a sliding movement of the driver unit relative to the door leaf and subsequently, after the driver unit strikes against the stop of the door leaf, leads to a common sliding movement of the driver unit and the door leaf.

The driver unit is preferably positioned at the top on the door leaf and is displaced on the upper face of the door leaf. For low-friction guidance of the driver unit, said driver unit is preferably guided by means of the guide rollers which are attached to the upper face of the door leaf. The adjustment device preferably extends vertically through the entire door leaf and protrudes upwardly therefrom on the upper face of the door leaf and protrudes downwardly therefrom on the lower face of the door leaf.

When the motorized drive unit is not in operation, the drive roller may be mechanically separated from the adjustment device and the door leaf. Alternatively, it may be provided that during operation and non-operation of the motorized drive unit the drive roller bears against the adjustment device and during manual door operation said drive roller is passively rotated therewith. The last variant is advantageous if the internal friction of the drive roller and/or the drive unit is sufficiently low when inactive, in order to permit a manual operation of the sliding door when the drive roller bears thereagainst, even for people of average physical strength without a great degree of effort.

It is regarded as particularly advantageous if the above-described sliding door is used in vehicles, in particular in rail vehicles. Accordingly, a vehicle, in particular a rail vehicle, is also regarded as part of the invention, said vehicle being provided with a sliding door, as has been described above.

The invention is described in more detail hereinafter with reference to exemplary embodiments; in which by way of example:

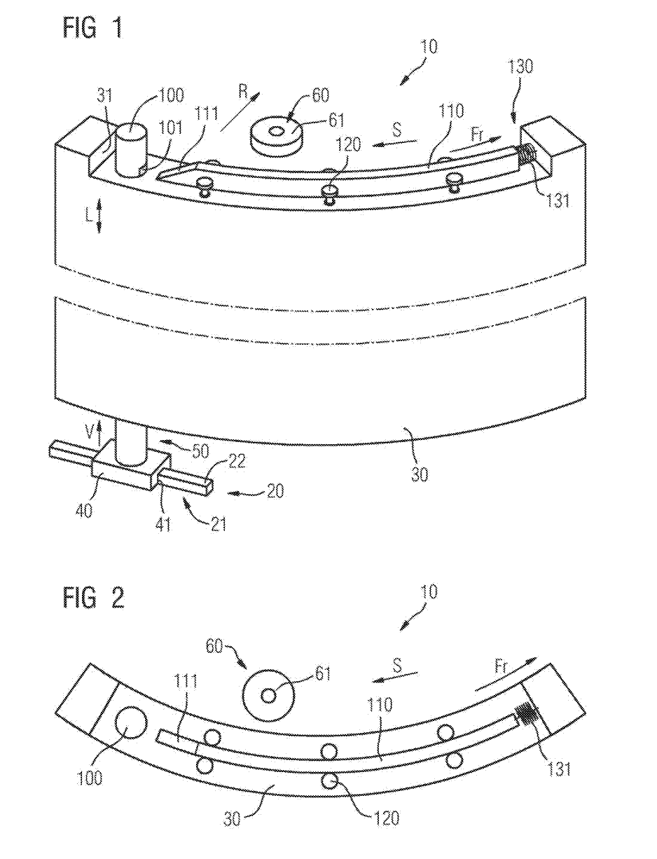

FIG. 1 shows an exemplary embodiment of a sliding door according to the invention in a three-dimensional view, wherein a brake element of the sliding door is located in its braking position,

FIG. 2 shows the sliding door according to FIG. 1 in a plan view,

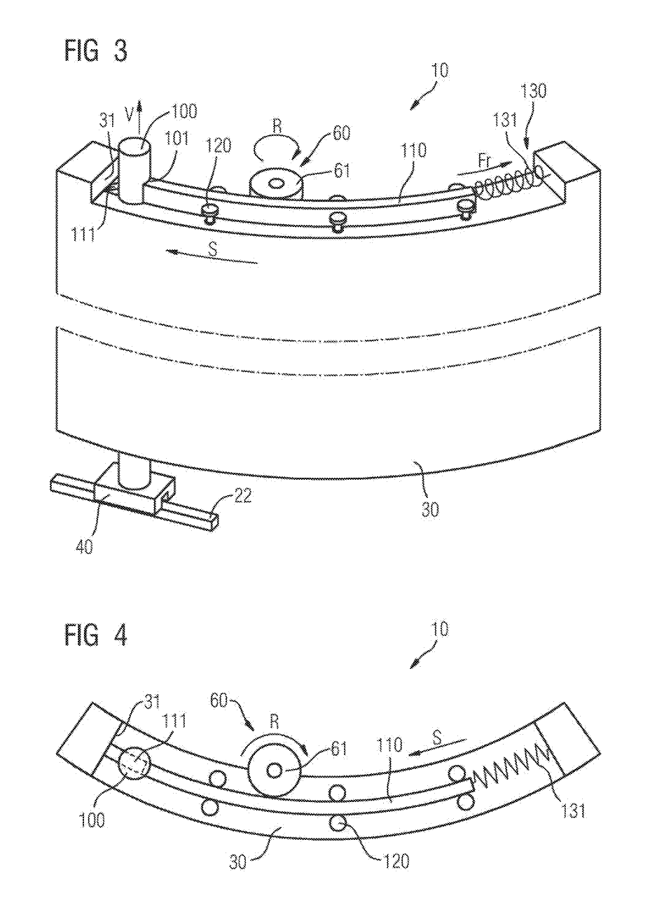

FIG. 3 shows the sliding door according to FIGS. 1 and 2 in a three-dimensional view, wherein the brake element is located in its release position,

FIG. 4 shows the sliding door according to FIG. 3 in a view from above,

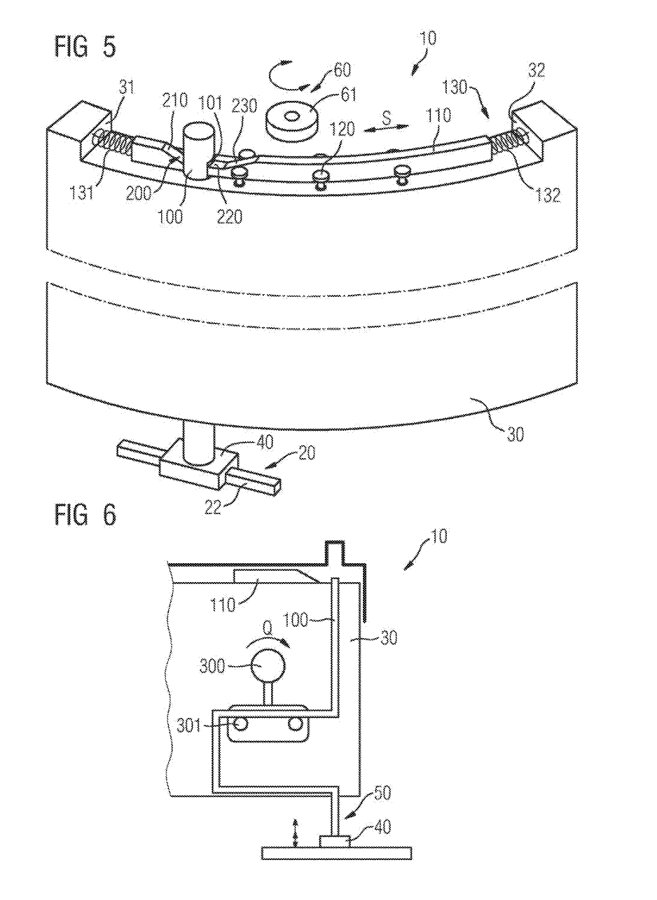

FIG. 5 shows a further exemplary embodiment of a sliding door according to the invention,

FIG. 6 shows an exemplary embodiment of a sliding door according to the invention in which a brake adjusting unit may be actuated for adjusting a brake element by means of a manual control element which also serves for opening and closing the sliding door,
wherein FIG. 6 shows the braking position of

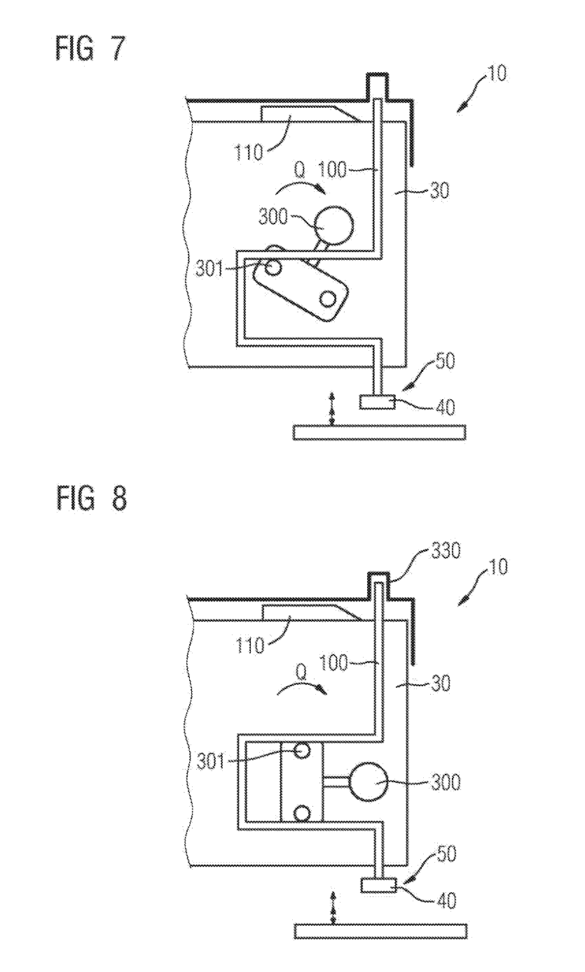

FIG. 7 shows the sliding door according to FIG. 6 in a position in which the brake element adopts its release position due to the action of the manual control element and the door leaf of the sliding door may be manually moved,

FIG. 8 shows the sliding door according to FIGS. 6 and 7, wherein by actuating the manual control element the brake adjusting unit has been moved into a position in which it engages in a recess on the frame side and blocks the door leaf and/or the sliding door as a whole against adjustment,

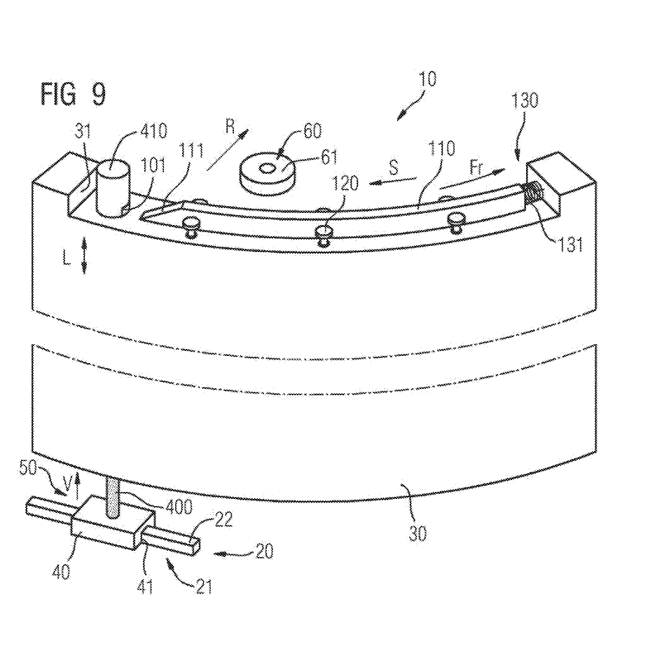

FIG. 9 shows an exemplary embodiment of a sliding door according to the invention in which an adjustment device is formed for adjusting a brake element by a wire or a cable, and

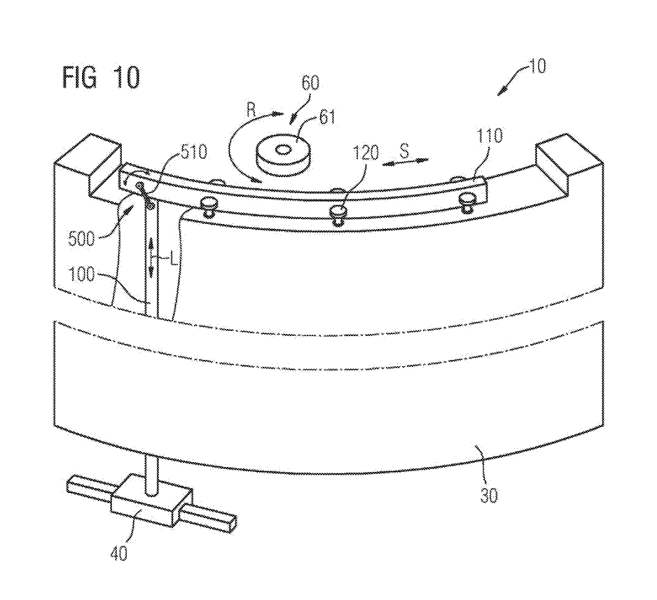

FIG. 10 shows an exemplary embodiment of a sliding door according to the invention in which an adjustment device comprises a coupling rod.

For the sake of clarity, the same reference numerals are always used for identical or similar components in the figures.

FIG. 1 shows a sliding door 10 of a rail vehicle 20 shown only by way of indication. The sliding door 10 comprises a door leaf 30 which may be displaced to the left in FIG. 1 in a sliding direction S marked by an arrow or alternatively—counter to the direction of the arrow—may be displaced to the right.

The position of the door leaf 30 may be blocked by means of a brake element 40 which in the view according to FIG. 1 adopts its braking position and thus prevents or at least hinders a sliding movement of the door leaf 30. The brake element 40 may be a brake shoe or brake piston which, for example, cooperates with a brake rail 22 on the vehicle side attached to the floor 21 of the rail vehicle 20. Regarding an optimal braking action of the brake element 40, it is regarded as advantageous if the brake element 40 has a slot 41, the brake element bearing thereby against the brake rail 22.

For adjusting the brake element 40 from the braking position shown in FIG. 1 into a release position in which the brake element 40 is separated from the brake rail 22, the sliding door 10 is provided with an adjustment device 50; by means of the adjustment device 50 the brake element 40 may be lifted and/or moved in the vertical direction V.

The adjustment device 50 cooperates with a motorized drive unit 60, for reasons of clarity only a drive roller 61 thereof being shown in FIG. 1. The drive roller 61 may, for example, be a friction roller which in the case of a rotation transfers its drive force in the direction of the arrow R by friction.

The adjustment device 50 has a brake adjusting unit in the form of a brake rod 100 which is able to be adjusted in the longitudinal direction of the rod L and/or in the arrangement according to FIG. 1 in the vertical direction.

In the exemplary embodiment according to FIG. 1 the cross section of the brake rod 100 is round; however this is only to be understood by way of example: instead of a round cross section the brake rod 100 may also have a different cross section, for example an oval or angled cross section. The brake rod also does not have to be solid and it may also be entirely or partially hollow and, as it were, entirely or partially tubular.

The brake rod 100 is provided with a through-opening 101 which cooperates with a driver unit in the form of a driver slide 110. The cooperation between the through-opening 101 and the driver slide 110 is based on a wedge surface 111 which, with a sliding movement of the driver slide 110, is pushed in the sliding direction S to the left into the through-opening 101 and through said through-opening.

In order to permit a sliding movement of the driver slide 110 in the sliding direction S with as little friction as possible, the sliding door 10 is provided with guide rollers 120 which may be mounted, for example, on the door leaf 30.

The sliding door 10 according to FIG. 1 is also provided with a spring drive 130 which has a restoring spring 131. The function of the restoring spring 131 is to produce a restoring force Fr which aims to displace the driver slide 110 to the right in the view according to FIG. 1 and thus pull the wedge surface 111 out of the through-opening 101 of the brake rod 100.

The driver slide 110 in the exemplary embodiment according to FIG. 1 is positioned at the top on the door leaf 30 and is displaced on the upper face of the door leaf. The guide rollers 120, which are preferably attached on the upper face of the door leaf 30, serve for low friction guidance of the driver unit. The brake rod 100 extends in the exemplary embodiment according to FIG. 1 vertically through the entire door leaf 30 and protrudes on the upper face of the door leaf upwardly therefrom (with its through-opening 101) in order to cooperate with the driver slide 110, and on the lower face of the door leaf 30 downwardly therefrom in order to cooperate with the brake element 40.

The sliding door 10 may be operated, for example, as follows:

s if the motorized drive unit 60 is in an inactive state in which it does not exert any drive force on the sliding door 10, the restoring force Fr of the restoring spring 131 ensures that the driver slide 110 in the view according to FIG. 1 is pulled to the right and thus the wedge surface 111 is pulled out of the region of the through-opening 101 of the brake rod 100. This state is shown in FIG. 1. As soon as the wedge surface 111 is pulled out of the region of the through-opening 101, the brake rod 100 alone is, due to gravity and/or by the spring force of a spring device, not shown further, lowered vertically downward, so that the brake element 40 is placed onto the brake rail 22 on the vehicle side, and by the friction between the brake element 40 and the brake rail 22 the door leaf 30 is braked or fully blocked. In other words, by the spring drive 130 and/or by the restoring spring 131 it is always ensured that, when the motorized drive unit 60 is inactive, the brake element 40 reaches its braking position and the door leaf 30 is blocked.

FIG. 2 shows the sliding door 10 according to FIG. 1 in a plan view. The door leaf 30, the guide rollers 120, the driver slide 110 being displaceably guided therebetween, and the brake rod 100 and the spring drive 130, may be seen.

In the view according to FIG. 2, the drive roller 61 of the motorized drive unit 60 is inactive and spatially separated from the driver slide 110. Such a spatial separation between the drive roller 61 and the driver slide 110, when the motorized drive unit 60 is inactive, it is not necessarily required; alternatively, even when the motorized drive unit 60 is switched off, the drive roller 61 is able to bear against the driver slide 110; in this case it is advantageous if the internal friction of the drive unit 60 is sufficiently low in order to ensure the rotation therewith of the drive roller 61 when the door leaf 30 is manually actuated, without too much force being expended.

In FIG. 2 may also be identified the action of the restoring spring 131 which pulls the driver slide 110 in FIG. 2 to the right, whereby the wedge surface 111 is pulled out of the region of the through-opening 101 of the brake rod 100 so that the brake rod 100 and thus the brake element 40 (see FIG. 1) may be lowered.

FIG. 3 shows the sliding door 10 according to FIGS. 1 and 2 when the motorized drive unit 60 is switched on and when the drive roller 61 acts on the driver slide 110 and—due to its rotation in the direction of the arrow R—displaces said driver slide in the sliding direction S to the left. The displacement of the driver slide 110 to the left takes place counter to the restoring force Fr of the restoring spring 131.

By the displacement of the driver slide 110, the wedge surface 111 is pushed into the through-opening 101 of the brake rod 100 and also through the through-opening 101, whereby the chamfer of the wedge surface 111 results in a lifting of the brake rod 100 in the direction of the arrow V. By the lifting of the brake rod 100 the brake element 40 is also lifted, so that it is separated from the brake rail 22 on the vehicle side and the brake element 40 reaches its release position. As soon as the brake element 40 is separated from the brake rail 22, the door leaf 30 may be moved.

If a further rotation of the drive roller 61 is carried out in the direction of the arrow R, the driver slide 110 strikes a stop 31 of the door leaf 30 on the door leaf side, whereby a further sliding movement of the driver slide 110 relative to the door leaf 30 is prevented. A further rotation of the drive roller 61 thus also leads to a sliding movement to the left, both of the driver slide 110 and of the door leaf 30 in the view according to FIG. 3.

In summary, therefore, when the motorized drive unit is switched on and/or in the case of a rotation of the drive roller 61 in the direction of the arrow R, by the displacement of the driver slide 110 relative to the door leaf 30, initially an unlocking of the brake element 40 occurs, before it results in a common movement of the door leaf 30 and the driver slide 110 in the sliding direction S, after the driver slide 110 has reached the stop 31.

As soon as the drive roller 61 is switched off, the restoring force Fr of the spring drive 130 results in a return movement of the driver slide 110 relative to the door leaf 30 counter to the sliding direction S, so that the driver slide 110 is pulled out of the through-opening 101 of the brake rod 100 and this leads to a renewed lowering of the brake element 40.

FIG. 4 shows the sliding door when the drive unit 60 is active, according to the operating state according to FIG. 3 in a view from above. It may be seen that the drive roller 61 bears against the driver slide 110 and displaces said driver slide in the sliding direction S to the left. Since the driver slide 110 has already reached the stop 31 on the door leaf side, the door leaf 30 is entrained with the driver slide 110 resulting in a common displacement of the driver slide 110 and the door leaf 30 in the sliding direction S, as already has been explained in detail in connection with FIG. 3.

FIG. 5 shows a further example of a sliding door 10 which may be used in a rail vehicle 20.

In the exemplary embodiment according to FIG. 5, the driver slide 110 is provided with a recess 200 which is formed by a left-hand wedge surface 210 in FIG. 5, a bottom resting surface 220 and a right-hand wedge surface is 230 in FIG. 5. FIG. 5 shows the resting position of the driver slide 110 which is adopted by the driver slide 110 as soon as the motorized drive unit 60 and/or the drive roller 61 is inactive. The position of the driver slide 110 is adjusted by the spring drive 130, which in the exemplary embodiment according to FIG. 5 comprises two restoring springs 131 and 132. When the drive roller 61 is inactive, the two restoring springs 131 and 132 displace the driver slide 110 such that the through-opening 101 of the brake rod 100 is located in the region of the bottom resting surface 220, so that the brake rod 100 may be lowered and the brake element 40 is able to reach the brake rail 22. In other words, when the drive unit 60 is inactive, the restoring springs 131 and 132 ensure that the brake element 40 is in its braking position.

If the motorized drive unit 60 is now activated and the drive roller 61 is set into rotational motion, irrespective of the rotational direction of the drive roller 61 it leads to a lifting of the brake element 40 and to a transfer of the brake element 40 from the braking position into the release position. Irrespective of the rotational direction of the drive roller 61 and/or irrespective of the sliding direction of the driver slide 110 one of the two wedge surfaces, whether this is the wedge surface 210 or the wedge surface 230, is always pushed into the region of the through-opening 101 of the brake rod 100, whereby it results—as explained—in the brake rod 100 being lifted.

After the driver slide 110 has been displaced relative to the door leaf 30 and the brake element 40 has been deactivated by the action of one of the two wedge surfaces 210 or 230, this leads to the driver slide 110 bearing against one of the two stops 31 or 32 on the door leaf side so that, depending on the sliding direction S of the driver slide 110, after reaching the door stop the door leaf 30 is entrained in the corresponding sliding direction.

In other words, in the exemplary embodiment according to FIG. 5 it is thus possible initially to deactivate the brake element 40 in both rotational directions of the drive roller 61 and/or both for closing the door leaf 30 and also for opening the door leaf 30, before it subsequently results in an opening or closing of the door leaf, by the door leaf 30 being entrained by the driver slide 110.

FIG. 6 shows an exemplary embodiment of a sliding door 10 in which the adjustment device 50, in particular the brake adjusting unit of the adjustment device 50, cooperates with a manual control element 300 which is suitable for manually opening or closing the sliding door 10.

FIG. 6 shows a position of the manual control element 300 in which the brake adjusting unit, which for example may comprise a brake rod 100 or may be formed by such a brake rod, is lowered and the brake element 40 of the sliding door 30 adopts its braking position.

If the manual control element 300 is now pivoted by pivoting in the direction of the arrow Q, a deflection element which, for example, may be a bolt 301, lifts the brake rod 100 so that the brake element 40 is also raised and moved from its braking position into its release position. This is shown in FIG. 7. In the position shown in FIG. 7 of the manual control element 300 the brake element 40 is disengaged and the door leaf 30 released so that by the action of force on the manual control element 300 the door leaf 30 may be opened or closed.

If the manual control element 300 is pivoted further in the direction of the arrow Q, it may—preferably exclusively in the fully closed position of the door leaf 30—lead to a further lifting of the brake rod 100 so that the brake rod 100 engages with its upper end in FIG. 8 in a recess 330 of the sliding door 10 on the frame side, and is able to fully block the position of the door leaf 30 by a positive connection with the frame of the sliding door.

In the exemplary embodiment according to FIGS. 6 to 8, the manual control element 300 thus has a plurality of functions: by means of the manual control element 300 the brake element 40 may be activated and deactivated, the sliding door may be opened or closed, when the brake element 40 is deactivated, and also—preferably in the closed position of the sliding door 10—the door leaf 30 may be locked by means of the brake rod 100.

FIG. 9 shows a further exemplary embodiment of a sliding door 10 in which an adjustment device 50 cooperates with a motorized drive unit 60. In the exemplary embodiment according to FIG. 9 the brake adjusting unit comprises a cable 400 which is connected to the brake element 40 and an upper connection element 410. The upper connection element 410 has a through-opening 101 which cooperates with the driver slide 110 as has been explained already in detail in connection with FIGS. 1 to 8.

By a displacement of the driver slide 110 and/or by an insertion or withdrawal of the wedge surface 111 from the region of the through-opening 101, the connection element 410 and thus the cable 400 may be lifted or lowered, whereby this results in an activation or deactivation of the brake element 40, as has already been described in is detail in connection with FIGS. 1 to 8. Reference is made to the above embodiments relative thereto.

FIG. 10 shows an exemplary embodiment of a sliding door 10 in which a driver unit—for example in the form of a driver slide 110—cooperates with the brake adjusting unit—for example in the form of a brake rod 100—rather than via a wedge surface via a coupling device 500. The coupling device 500 comprises at least one coupling rod 510 which indirectly or directly connects the driver slide 110 and the brake rod 100 and, with a movement of the driver slide 110 in the sliding direction S, triggers a movement of the brake rod 100 vertically or obliquely thereto. The lifting or lowering of the brake rod 100 results in an activation or deactivation of the brake element 40 as has been explained in detail already in connection with FIGS. 1 to 9. Reference is made to the above embodiments relative thereto.

Whilst the invention has been illustrated and described in more detail by preferred exemplary embodiments, the invention is not limited by the disclosed examples and other variants may be derived therefrom by the person skilled in the art without departing from the protected scope of the invention.

1-15. (canceled)

16. A sliding door, comprising:
a door leaf;
a brake element for braking said door leaf;
an adjustment device for switching said brake element over from a braking position in which said door leaf is being braked, to a release position in which said door leaf is not being braked, and vice versa from the release position to the braking position; and
a motorized drive unit configured to cooperate with said adjustment device and to allow said brake element to be adjusted.

17. The sliding door according to claim 16, wherein said motorized drive unit is configured to displace said door leaf in a direction of a closed position of said door leaf.

18. The sliding door according to claim 16, wherein said motorized drive unit is able to displace said door leaf in a direction of a closed position of said door leaf and optionally in a direction of an open position of said door leaf.

19. The sliding door according to claim 16, wherein said adjustment device contains a strand-shaped or rod-shaped brake adjusting unit which is connected to said brake element and which in a case of a displacement in a longitudinal direction of said brake adjusting unit transfers said brake element from the braking position into the release position or vice versa.

20. The sliding door according to claim 19, wherein said adjustment device has a displaceable driver unit, which by displacement transversely, to the longitudinal direction of said brake adjusting unit, is able to displace, said brake adjusting unit in the longitudinal direction.

21. The sliding door according to claim 20, wherein said displaceable driver unit or said brake adjusting unit has a wedge surface which is oriented obliquely to the longitudinal direction and which, in a case of a sliding movement of said displaceable driver unit transversely to the longitudinal direction, triggers a movement of said brake adjusting unit in the longitudinal direction.

22. The sliding door according to claim 21, wherein said wedge surface is oriented obliquely to vertical and, in a case of the sliding movement of said displaceable driver unit in a horizontal direction, triggers a vertical movement of said brake adjusting unit.

23. The sliding door according to claim 20, wherein said displaceable driver unit is able to be displaced along a same linear or curved sliding path, said door leaf being displaced along the sliding path when the sliding door is opened or closed.

24. The sliding door according to claim 20, further comprising at least one coupling rod, said displaceable driver unit and said brake adjusting unit are coupled together via said least one coupling rod which, in a case of the sliding movement of said displaceable driver unit transversely to the longitudinal direction, triggers a movement of said brake adjusting unit in the longitudinal direction.

25. The sliding door according to claim 16, wherein said motorized drive unit, said adjustment device and said door leaf are disposed relative to one another such that said motorized drive unit, when started up to adjust said door leaf, initially acts on said adjustment device and permits said brake element to be transferred from the braking position into the release position before said door leaf is driven.

26. The sliding door according to claim 20, wherein:
said door leaf has a stop;
said motorized drive unit, said adjustment device, said door leaf and said stop on said door leaf side are disposed such that:
said motorized drive unit, when started up to adjust said door leaf, initially displaces said displaceable driver unit transversely to the longitudinal direction of said brake adjusting unit and relative to said door leaf, whereby said brake element is transferred from the braking position into the release position and namely until said displaceable driver unit strikes against said stop on a door leaf side; and
after said displaceable driver unit comes to bear against said stop, a drive force of said motorized drive unit is transmitted to said door leaf and said door leaf is displaced via said displaceable driver unit bearing against said stop.

27. The sliding door according to claim 20, wherein said adjustment device has a spring drive which transfers said brake element indirectly or directly, by cooperation of said displaceable driver unit, from the release position into the braking position as soon as said motorized drive unit is inactive.

28. The sliding door according to claim 20, wherein:
said door leaf has a stop;
said motorized drive unit contains a drive roller which bears against said displaceable driver unit at least during operation of said motorized drive unit and is set in rotational motion for adjusting said adjustment device and said door leaf; and
said drive roller, when rotated by friction and/or a form-locking connection, initially leads to the sliding movement of said displaceable driver unit relative to said door leaf and subsequently, after said displaceable driver unit strikes against said stop of said door leaf, leads to a common sliding movement of said displaceable driver unit and said door leaf.

29. The sliding door according to claim 16, further comprising a manual control element for opening and closing said door leaf and being connected to said adjustment device and when actuated permits an adjustment of said brake element from the braking position into the release position and—in a closed position of the sliding door—permits a locking of said door leaf.

30. The sliding door according to claim 28, wherein said drive roller is a friction roller.

31. The sliding door according to claim 19, wherein said brake adjusting unit is selected from the group consisting of a brake rod, a brake tube, a cable and a wire.

32. The sliding door according to claim 20, wherein said displaceable driver unit is a driver slide.

33. A rail vehicle, comprising:
a sliding door, containing:
a door leaf;
a brake element for braking said door leaf;
an adjustment device for switching said brake element over from a braking position in which said door leaf is being braked, to a release position in which said door leaf is not being braked, and vice versa from the release position to the braking position; and
a motorized drive unit configured to cooperate with said adjustment device and to allow said brake element to be adjusted.
